(19) United States
(12) Patent Application Publication
(10) Pub. No.: US 2023/0033352 A1
(43) Pub. Date: Feb. 2, 2023

(54) TIME-OF-FLIGHT OBJECT DETECTION CIRCUITRY AND TIME-OF-FLIGHT OBJECT DETECTION METHOD

(71) Applicant: Sony Semiconductor Solutions Corporation, Kanagawa (JP)

(72) Inventors: Aliaksandr KAMOVICH, Stuttgart (DE); Vladimir ZLOKOLICA, Stuttgart (DE)

(73) Assignee: Sony Semiconductor Solutions Corporation, Kanagawa (JP)

(21) Appl. No.: 17/781,388

(22) PCT Filed: Dec. 16, 2020
(86) PCT No.: PCT/EP2020/086425

§ 371 Date: Jun. 1, 2022

(30) Foreign Application Priority Data
Dec. 23, 2019 (EP) 19219552.7

(51) Int. Cl. G01S 17/894

(52) U.S. Cl. CPC G01S 17/894

(57) ABSTRACT

The present disclosure generally pertains to a time-of-flight object detection circuitry configured to: obtain reflectivity data being indicative of reflectivity of a scene; determine the reflectivity of the scene; determine a region of an object in the scene based on the determined reflectivity; and generate time-of-flight image data based on the determined region of the object for detecting the object.

### TECHNICAL FIELD

The present disclosure generally pertains to a time-of-flight object detection circuitry and a time-of-flight object detection method.

### TECHNICAL BACKGROUND

Generally, object detection methods and system are known. Such systems usually perform an object detection (or object recognition) based on RGB data, on a luminance distribution (e.g. greyscale), or the like.

Moreover, time-of-flight systems are known. Typically, in time-of-flight, a run-time of emitted light, which is reflected at a scene, is measured for determining a distance to the scene.

This can be done by directly measuring a time from an emission of the light to a detection of the reflected light, which is generally known as dToF (direct time-of-flight).

On the other hand, in a case of iToF (indirect time-of-flight), a phase shift is measured, which is indicative of the run-time.

Although there exist techniques for object detection, it is generally desirable to provide a time-of-flight object detection circuitry and a time-of-flight object detection method.

### SUMMARY

According to a first aspect, the disclosure provides a time-of-flight object detection circuitry configured to: obtain reflectivity data being indicative of reflectivity of a scene; determine the reflectivity of the scene; determine a region of an object in the scene based on the determined reflectivity; and generate time-of-flight image data based on the determined region of the object for detecting the object.

According to a second aspect, the disclosure provides a time-of-flight object detection method comprising: obtaining reflectivity data being indicative of reflectivity of a scene; determining the reflectivity of the scene; determining a region of an object in the scene based on the determined reflectivity; and generating time-of-flight image data based on the determined region of the object for detecting the object.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 depicts, in a block diagram, a time-of-flight imaging method according to the present disclosure;

FIG. 2 depicts, in a block diagram, a further embodiment of a time-of-flight imaging method according to the present disclosure;

FIG. 3 shows a further embodiment of a time-of-flight imaging method according to the present disclosure in a block diagram;

FIG. 4 depicts a time-of-flight imaging system according to the present disclosure in a block diagram;

FIG. 5 depicts an embodiment of a method for obtaining ALR data, MAAR data, and depth data according to the present disclosure; and

FIG. 6 illustrates an embodiment of a time-of-flight imaging apparatus according to the present disclosure.

### DETAILED DESCRIPTION OF EMBODIMENTS

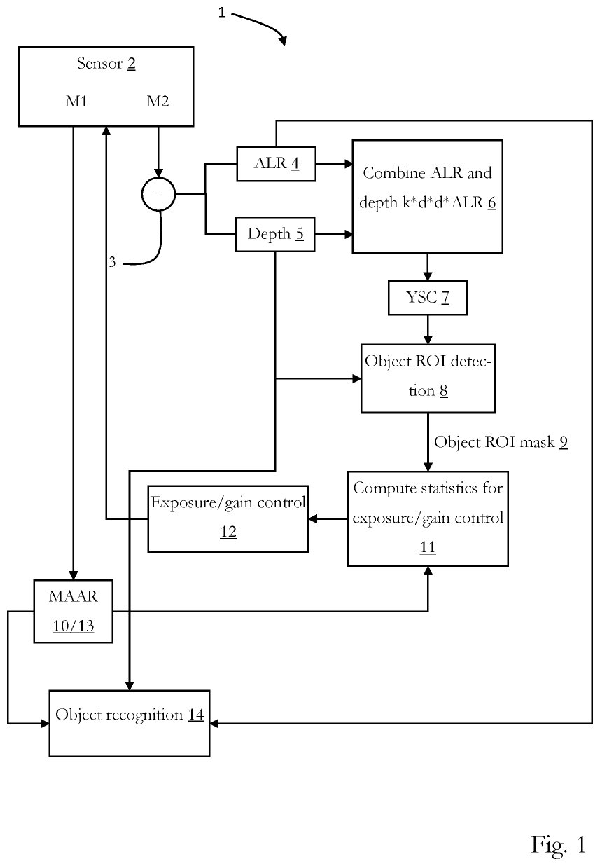

Before a detailed description of the embodiments under reference of FIG. 1 is given, general explanations are made.

As mentioned in the outset time-of-flight imaging systems are known.

It has been recognized that in a time-of-flight imaging signal from a time of flight sensor, an active light reflectance (ALR) signal can be obtained.

However, in known systems, such a signal can be deteriorated based on a distance to an object. For example, if the object is close to a camera, it may seem brighter than if it is further away from the camera. Therefore, such a signal is typically not suitable for a computer vision, such as an object recognition.

Moreover, it has been recognized that, in the case of time-of-flight, an actual distance to such an object may be obtained additionally to the ALR signal. Hence, it has been recognized that such a deterioration of the reflectance can be compensated for by knowing the distance (or the depth), or, vice versa, a distance measurement may be improved based on the reflectivity.

Additionally to the active light reflectivity data (or ALR data) and depth data, a time-of-flight imaging system may be able to provide a YSC signal (Y channel and surface characteristic), which may include luminance information (such as a Y channel of a monochromatic camera, as it is generally known) and a surface characteristic, which may be indicative of a reflection and/or an absorption of the object (or a material).

Hence, it has been recognized that by exploiting such signals (which may be summarized to a YSC-D signal (Y-channel, surface characteristic, and depth) together with the ALR signal) of a time-of-flight imaging system, an object region detection, an object detection, and an object recognition may be carried out.

In known systems, such signals may not be used or combined optimally. For example, a time-of-flight signal in known systems may be distance dependent, may have increased motion blur, may not have optimal exposure control, may have increased specular reflection, or the like. Hence, in known systems, a dynamic exposure and/or gain control based on the reflectivity of the object is not envisaged, and it has been recognized that it is desirable to provide a dynamic exposure/gain control in the field of time-of-flight.

Therefore, in known systems, an object detection or recognition may not be optimal.

Furthermore, it has been recognized that it is desirable to improve face recognition and/or a face authentication, for example in an automotive area or in a mobile application, without limiting the present disclosure in that regard.

Therefore, some embodiments pertain to a time-of-flight object detection circuitry configured to: obtain reflectivity data being indicative of reflectivity of a scene; determine the reflectivity of the scene; determine a region of an object in the scene based on the determined reflectivity; and generate time-of-flight image data based on the determined region of the object for detecting the object.

According to the present disclosure, it may be possible to generate a distance independent reflectivity signal, which may be used together with a determined depth (or distance) signal, or on which a depth determination may be based, such that a detection of a region of an object, a feature extraction, an object recognition, or the like may be performed efficiently.

The time-of-flight object detection circuitry may be applicable to any time-of-flight technology, such as indirect time-of-flight (iToF), direct time-of-flight (dToF), and the like.

Generally, in iToF, a depth or a distance is determined by evaluating at least one phase shift of emitted modulated light. Thereby, it can be concluded to a run-time of the light, which indicates a distance to an object or a scene.

In dToF, a depth is determined by measuring a run-time of emitted light directly. Typically, the run-time can be determined by detecting an event caused by a returning (due to a reflection) of the emitted light and comparing a point of time at which the event is detected to a point of time at which the light is emitted.

Basically, in the scope of time-of-flight, reflectivity (or reflectance) of the scene and/or the object can be obtained, as discussed above. Either generated time-of-flight image data include information about the reflectivity, or it may be determined in a separate measurement. Generally, the reflectivity may also be obtained by a different technology than a time-of-flight technology.

The reflectivity may be determined, for example, by comparing an amount (e.g. an intensity) of emitted (modulated) light to an amount of received light. Moreover, the reflectivity may be indicated by confidence data, as it is generally known in the field of time-of-flight.

For example, the confidence data may be, in the case of iToF, a rough (fast) measurement of different phases of a generated light signal. Thereby, an active light reflectance (ALR) signal may be obtained from which the reflectivity may be concluded from.

Moreover, the reflectivity may be based on a predetermined wavelength range. Typically, the predetermined wavelength range may correspond to a wavelength range of the emitted light. Thereby, it may be possible to obtain reflectivity and a depth in one measurement.

The predetermined wavelength range may include visible light (e.g. of a predetermined color channel, e.g. red, blue, and the like), infrared, ultraviolet, and the like. Generally, the present disclosure is not limited to any wavelength range.

As it is generally known, a reflectivity of an object may depend on the wavelength range. For example, an object may have a reflectivity of eighty percent in a predetermined infrared wavelength range, whereas the same object may have a reflectivity of forty percent in a predetermined visible wavelength range (e.g. in a green color channel).

Hence, some objects may be better visible, and, thus, detectable in corresponding wavelength ranges, or, in other words: for each wavelength range, reflectivities of different objects may be known. For example, in a predetermined wavelength range (e.g. infrared), a first object may have a first reflectivity, and a second object may have a second reflectivity (without limiting the present disclosure to two different reflectivities or objects), such that by detecting the first reflectivity, the first object may be detected and by detecting the second reflectivity, the second object may be detected.

The time-of-flight object detection circuitry may, in this context, include any circuitry suitable for evaluating data, such as time-of-flight data, reflectivity data, and the like.

Hence, the circuitry may include a processor, such as a CPU (Central Processing Unit), a GPU (Graphic Processing Unit), an FPGA (Field Programmable Gate Array), and the like. Also, multiple of the named processors (or other processors) may be connected to form a circuitry according to the present disclosure.

Moreover, the circuitry may include a computer, a server, multiple computers and/or servers, and the like, as it is generally known.

The time-of-flight object detection circuitry is, in some embodiments, configured to obtain reflectivity data being indicative of reflectivity of a scene.

Reflectivity, as discussed above, may be indicative of at least one material property of at least one material (e.g. of an object) of the scene, and the like. Generally, the reflectivity may indicate an amount of light being reflected at the scene, object, material, and the like, compared to an incident amount of light, compared to an absorbed amount of light, compared to a transmitted amount of light, and the like, as it is generally known.

The reflectivity data may be obtained from an imaging circuitry, for example, which may be configured to generate the reflectivity data.

The imaging circuitry may pertain to or include an image sensor, a data storage, and the like, and it may be configured to actively provide the reflectivity data to the time-of-flight object detection circuitry, such that the time-of-flight object detection circuitry may be configured to (passively) receive the reflectivity data. Moreover, the imaging circuitry may be configured to provide the reflectivity data based on a request of the time-of-flight object detection circuitry, such that the time-of-flight object detection circuitry may (actively) acquire the reflectivity data.

Moreover, the reflectivity data may be directly obtained from (out of) image data (e.g. an electric signal which is created based on a photoelectric conversion) by the time-of-flight object detection circuitry.

In such embodiments, the time-of-flight object detection circuitry may be coupled to, included in, or include an image sensor, such that image data may be directly processed to determine the reflectivity data.

In some embodiments, the time-of-flight object detection circuitry is further configured to determine the reflectivity of the scene.

For example, the time-of-flight object detection circuitry may compare a light intensity of emitted light with a light intensity of detected light for each imaging element (e.g. pixel) of an image sensor, such that for every imaging element, a reflectivity may be determined.

Thereby, a reflectivity image or a reflectivity distribution in a two- or three-dimensional space may be determined, such that regions with different reflectivities may be localized.

For example, an object may have a different reflectivity than a background of the scene, such that, in some embodiments, a region of the object in the scene may be determined based on the determined reflectivity.

However, the present disclosure is not limited to the region of the object as any region of interest (ROI) may be determined based on the reflectivity.

Thereby, a reflectivity value, which is independent of a distance to the object or to the scene, can be obtained, which may be a function of depth information and reflectivity data (or ALR, as discussed herein).

In some embodiments, a depth measurement may be additionally performed for obtaining the depth information, or, based on the image data, depth data may be obtained (in a similar or different way than the reflectivity data), such that the region of the object may be determined or determinable based on the determined depth.

In some embodiments, the depth information may be smoothed (e.g. by a Gaussian filter).

For example, an object and its background may have a same or similar reflectivity or the difference of their respective reflectivities may be below a (predetermined) (detectable) threshold, such that it may not be possible to detect the region of the object based on the reflectivity.

In such embodiments, the region of the object may be determined, for example, based on a depth threshold. For example, if a predetermined difference detected by at least two imaging elements is above the depth threshold, a boundary between the object and the background may be determined. Thereby, the region of the object may be determined, as well.

In some embodiments, based on the determined region of the object, time-of-flight image data may be generated for detecting the object.

As it is generally known, a perception of an object may depend on the used optical system. For example, an object may seem brighter when it is closer to the optical system and darker when it is further away. This may also apply in the case of time-of-flight images, such that a depth measurement may be deteriorated when the object is moved out of an ideal focal plane. Moreover, since a depth of a three-dimensional object is measured, an extent of the focal plane may be smaller than an extent of the object, such that a part of the object may be imaged properly, whereas at least at one other part, a depth measurement may be deteriorated.

Such a perception may also depend on reflectivity of the object. Hence, direct usage of reflectivity or reflectivity data for computer vision (e.g. object recognition) is typically not envisaged in the art, wherein, typically, computer vision is based on RGB, luminance (e.g. greyscale) of the object, and the like.

Therefore, the determined region of the object may be taken into account for making an assumption of a depth. Moreover, the determined reflectivity may be adopted for correcting an existing depth measurement.

Generally, time-of-flight image data may be generated. This may include an adaption of preexisting image data (as described above) (of a current image frame), and it may further include an adaption of measurement parameters for a subsequent measurement, such as a gain, an exposure time, and the like.

Hence, in some embodiments, the time-of-flight object detection circuitry is further configured to adjust an exposure time based on the determined reflectivity for generating the time-of-flight image data.

The exposure time, as it is generally known may include a time after which a shutter (electronic and/or mechanic) may be triggered, such that an image acquisition may stop, compared to a start of the image acquisition.

In some embodiments, the time-of-flight object detection circuitry is further configured to adjust a gain based on the determined reflectivity for generating the time-of-flight image data.

Generally, the exposure time and the gain may both be adjusted, whereas, in some embodiments, only one of the exposure time and the gain is adjusted.

Generally, the present disclosure is not limited to the case of an exposure time and a gain, such that any imaging parameter or measurement parameter may be adapted, such as an ISO value (based on ISO 5800, as it is generally known), and the like.

Generally, according to the present disclosure, an adaption of the gain and/or the exposure time may be improved, in particular in terms of object region detection, object detection and object recognition.

Moreover, as discussed above, and as it is generally known, an image acquisition may include a plurality of imaging frames (or sub-frames).

For example, in a first frame (or current frame) image data may include reflectivity data and time-of-flight image data, such that the time-of-flight image data may be generated or corrected based on the reflectivity data of the same frame.

Moreover, in any subsequent frame (i.e. any frame which is acquired after an obtaining of reflectivity data) time-of-flight image data may be generated based on the reflectivity data (or based on the region of the object, as discussed herein.

Moreover, in every frame (or in multiple frames), reflectivity data may be obtained for generating time-of-flight image data. However, in some embodiments, it may be sufficient, at roughly constant environmental conditions (e.g. constant lighting, constant position of the camera and/or the object), to obtain the reflectivity data once.

In some embodiments, the time-of-flight object detection circuitry is further configured to detect the object based on the determined reflectivity.

Detecting the object may pertain to detecting the presence of the object based on the region of the object. For example, by determining a predetermined reflectivity (as discussed above) and locating the region of the object, the object may be detected, wherein it may not be recognized which kind of object is detected, i.e. the object may not be recognized.

For example, the detection of the object may refer to an assignment of the predetermined reflectivity to an object class. For example, the object class may refer to a reflectivity of a predetermined reflectivity range of the object, such as a reflectivity of human skin of roughly eighty percent in a low infrared range. Hence, by determining a reflectivity of eighty percent, the object class human body part may be determined, wherein the exact body part (e.g. face, hand) may not be recognized yet.

However, in some embodiments, the time-of-flight object detection circuitry is further configured to recognize the object based on the reflectivity and based on the generated time-of-flight image data.

As mentioned above, the time-of-flight image data may be indicative of a depth information or a depth image of the detected object. Thereby, a depth structure of the detected object may be determined in which at least one feature may be recognized, such that the object may be recognized.

The object recognition may be based on known methods, such as an artificial intelligence, and the like.

The artificial intelligence (AI) may use machine learning based methods or explicit feature based methods, such as shape matching, for example by edge detection, histogram based methods, template match based methods, color match based methods, or the like. In some embodiments, a machine learning algorithm may be used for performing object recognition, e.g. for comparing a detected predefined object with a recognized object to increase a correctness of a detection, which may be based on at least one of: Scale Invariant Feature Transfer (SIFT), Gray Level Co-occurrence Matrix (GLCM), Gabor Features, Tubeness, or the like. Moreover, the machine learning algorithm may be based on a classifier technique, wherein such a machine learning algorithm may be based on least one of: Random Forest; Support Vector Machine; Neural Net, Bayes Net, or the like. Furthermore, the machine learning algorithm may apply deep-learning techniques, wherein such deep-learning techniques may be based on at least one of: Autoencoders, Generative Adversarial Network, weakly supervised learning, boot-strapping, or the like.

The supervised learning may further be based on a regression algorithm, a perceptron algorithm, Bayes-classification, Naiver Bayer classification, next-neighbor classification, artificial neural network, and the like.

The artificial intelligence may, in such embodiments, be fed with ground truth data, which may correspond to or be based on the predefined object, such that the artificial intelligence may learn to recognize the object.

In some embodiments, the recognizing is based on a predetermined object class, as discussed herein.

In some embodiments, the predetermined object class is defined based on a predetermined reflectivity range of the object, as discussed herein.

In some embodiments, the object includes a body part.

Generally, the present disclosure is not limited to a human body part, as any part of any body (of an animal, and the like) may be recognized. Moreover, the present disclosure is not limited to the object being a body part as any object may be detected.

In some embodiments, the body part includes a face, as discussed herein.

Some embodiments pertain to a time-of-flight object detection method including: obtaining reflectivity data being indicative of reflectivity of a scene; determining the reflectivity of the scene; determining a region of an object in the scene based on the determined reflectivity; and generating time-of-flight image data based on the determined region of the object for detecting the object, as discussed herein.

The time-of-flight object detection method may be carried out with a time-of-flight object detection circuitry according to the present disclosure.

In some embodiments, the time-of-flight object detection method further includes adjusting an exposure time based on the determined reflectivity for generating the time-of-flight image data, as discussed herein. In some embodiments, the time-of-flight object detection method further includes adjusting a gain based on the determined reflectivity for generating the time-of-flight image data, as discussed herein. In some embodiments, the generated time-of-flight image data includes at least one of a current image frame and at least one subsequent image frame, as discussed herein. In some embodiments the time-of-flight object detection method further includes detecting the object based on the determined reflectivity, as discussed herein. In some embodiments, the time-of-flight object detection method of claim 15, further includes recognizing the object based on the reflectivity and based on the generated time-of-flight image data, as discussed herein. In some embodiments, the recognizing is based on a predetermined object class, as discussed herein. In some embodiments, the predetermined object class is defined based on a predetermined reflectivity range of the object. In some embodiments, the object includes a body part, as discussed herein. In some embodiments the body part includes a face, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is depicted, in a block diagram, a time-of-flight imaging method 1 according to the present disclosure.

A time-of-flight image sensor 2 provides image data M1 and M2, which are representative of a scene including an object.

At 3, from the image data M2 active light reflection data (ALR data) 4 (or reflectivity data as discussed herein) and depth data 5 (or time-of-flight data as discussed herein) are filtered and extracted.

At 6, the ALR data 4 and the depth data 5 are combined by multiplying a constant k with the squared depth signal d*d and multiplying with the ALR signal.

In this formula k*d*d*ALR, the depth d compensates for the distance dependent ALR signal, such that the result is independent of the distance.

This formula is, in this embodiment, an empirical formula. However, the present disclosure is not limited in that regard such that any formula may be applied.

Thereby, at 7, a YSC signal is generated, which indicates a luminance and surface characteristic.

The YSC signal is, in an approximation, similar to an output of a monochromatic camera (i.e. a Y channel). However, additionally to the monochromatic information, information about a reflection and/or absorbance of the scene (or generally about a surface characteristic) (and/or the object) are represented by the YSC signal.

As discussed herein, the YSC signal includes a surface characteristic and a luminance. Based on this signal, a clustering approach can be adopted for distinguishing between the object and the surrounding material (or the scene) (i.e. determining the region of interest at 8), wherein the luminance of the YSC signal can be used for the detection and/or the recognition of the object (as discussed below).

At 8, a region of interest (ROI) representing a region of the object, as discussed above, is determined based on the depth data and the YSC signal.

Based on this, an object ROI mask is generated, which is, at 9, used for a computation of statistics for exposure time and gain control 11. Moreover, an MAAR signal 10 (mixed ambient light and active light reflection signal), which is based on the signal M1 of the sensor 2 is used for the computation at 11.

The computation of the statistics based on the ROI mask may for example include an ROI signal intensity estimate (e.g. average), which can be used for adjusting an exposure and a gain (as described below).

The MAAR signal contains an unknown amount of ambient light (or, in other embodiments a known (exact) amount of ambient light and active light contribution). Therefore, an MAAR signal, if unprocessed can have a low quality, e.g. in terms of optimal brightness and contrast.

However, as discussed herein (further below), the MAAR signal may be suitable for reducing a motion blur artifact of the object.

At 12, a control value for the exposure time and the gain is determined, which is fed to the sensor 2 (including control circuitry to control the exposure time and the gain, not depicted), in a recursive manner.

Thus, for each frame, the information of the previous frame is used for improving an imaging quality of the frame. Moreover, a change in brightness (brightness flicker) which would be above a predetermined threshold is avoided.

Thereby, an in terms of brightness and contrast optimized (subsequent) image frame can be generated, i.e. in a subsequent frame, an (optimized) MAAR signal 13 is generated from the image signal Ml, which is used for an object recognition 14.

Moreover, the ALR data 4 and the depth data 5 are used for the object recognition 14.

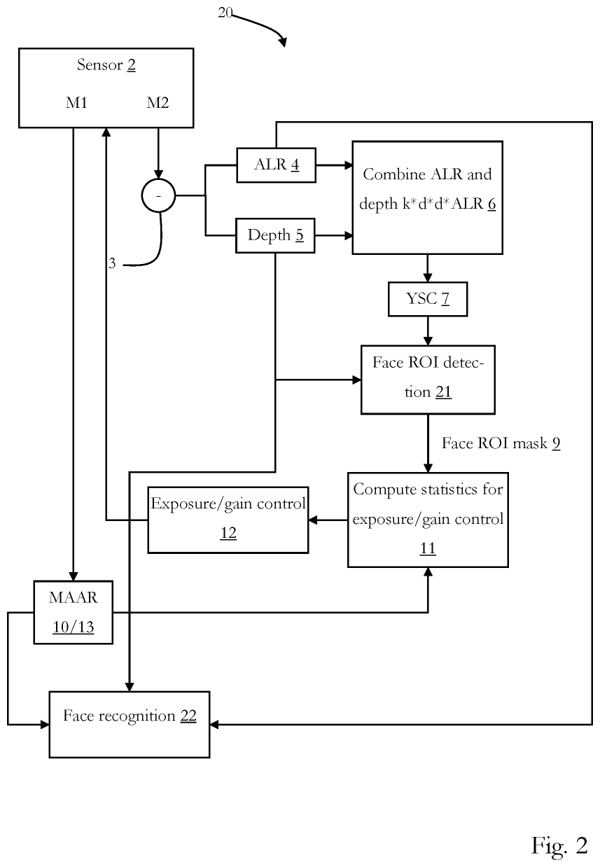

FIG. 2 depicts, in a block diagram, a further embodiment of a time-of-flight object detection method 20, which is different from the time-of-flight object detection method 1 of FIG. 1 in that a face ROI detection is performed at 21 instead of an object ROI detection (at 8), and in that a face recognition is performed at 22 instead of an object recognition (at 14), such that 8 and 14 are replaced with 21 and 22, respectively, and a repetitive description of the remaining blocks of the block diagram is omitted, since the according steps are the same as of the first embodiment of FIG. 1.

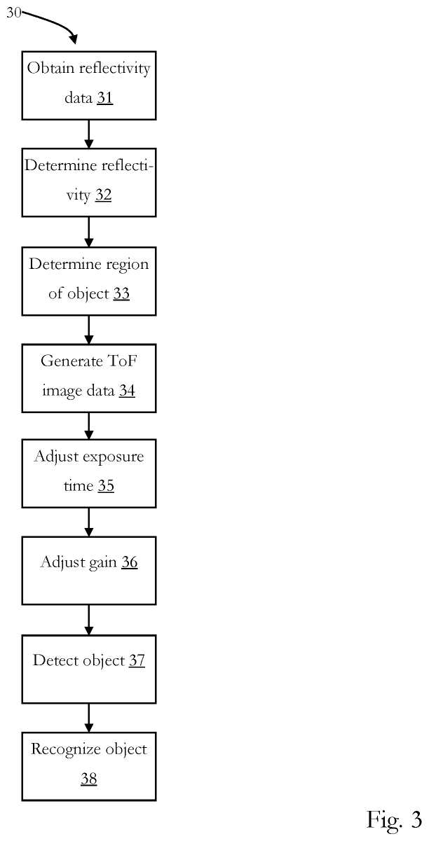

FIG. 3 shows a further embodiment of a time-of-flight object detection method 30 in a block diagram.

At 31, reflectivity data being indicative of reflectivity of a scene is obtained from a confidence measurement of a time-of-flight image sensor.

At 32, based on the reflectivity data, the reflectivity of the scene is obtained.

At 33, based on the determined reflectivity, and based on a reflectivity range, as discussed above, a region of an object in the scene is determined.

At 34, based on the reflectivity and the region of the image time-of-flight image data is generated, as discussed herein.

At 35 and 36, an exposure time and a gain are adjusted, respectively, as discussed herein.

At 37, the object is detected, as discussed herein.

At 38, the object is recognized, as discussed herein.

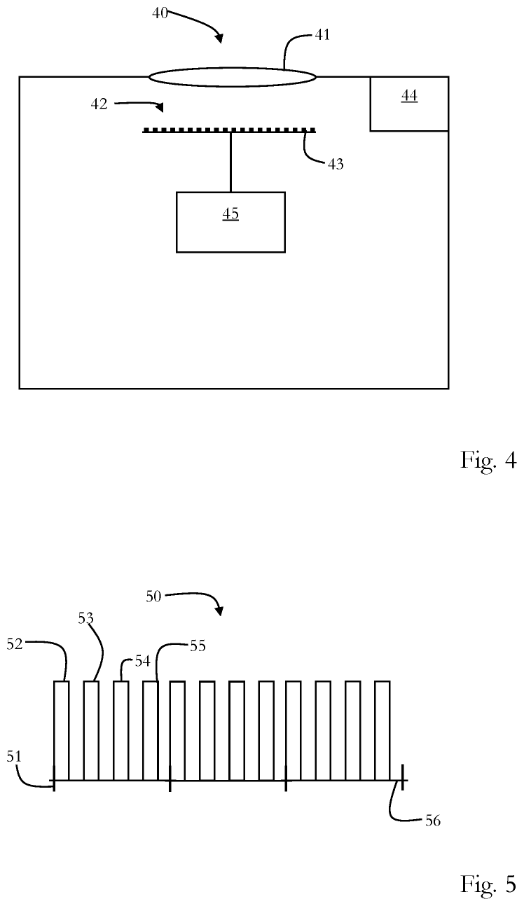

FIG. 4 depicts a time-of-flight imaging system 40 according to the present disclosure in a block diagram, which may be configured to implement and/or execute at least one of the methods 10, 20 and 30 of FIGS. 1, 2 and 3, respectively.

The time-of-flight imaging system 40 is adapted as a time-of-flight camera having a lens stack 41 being configured to focus light onto a time-of-flight image sensor 42 including a plurality of pixels 43. The pixels 43 include CAPDs (current assisted photonic demodulators) and each pixel 43 is configured to generate reflectivity data and depth data, as discussed herein.

The time-of-flight imaging system further has a light source 44 including a plurality of VCSELs (vertical cavity surface emitting lasers) which are configured to emit modulated light.

In this embodiment, the time-of-flight imaging system is measuring a phase shift of the emitted light. However, the present disclosure is not limited to this case (i.e. iToF), as discussed above, as any time-of-flight technology may be applied.

The time-of-flight imaging system further includes time-of-flight object detection circuitry 45 according to the present disclosure, which is, in this embodiment adapted as a CPU, and is configured to execute a time-of-flight object detection method according to the present disclosure, such as the time-of-flight object detection method 1, as described under reference of FIG. 1, without limiting the present disclosure in that regard, since, in other embodiments, corresponding time-of-flight object circuitry are adapted to execute the time-of-flight object detection method 20 of FIG. 2 or the time-of-flight object detection method 30 of FIG. 3, and the like.

FIG. 5 depicts an embodiment of a method 50 for obtaining reflectivity data or ALR data, MAAR data (or signal) and depth data, as described under reference of FIG. 1, for example, wherein a time-of-flight imaging system, such as the time-of-flight imaging system 40, which is described under reference of FIG. 4, is used.

At 51, the time-of-flight measurement is started.

Reference signs 52 to 55 represent four subsequent sub-frames, which in the case of iToF may be referred to components or phases and in the case of dToF may be referred to measurements.

The sub-frames are acquired one after another, such that a scale 56 represents a time.

In one time-of-flight measurement, i.e. between two starting points 51, one frame is acquired.

One sub-frame, e.g. the sub-frame 52, represents an integration time for a single component (in the iToF case), wherein a time between two sub-frames, e.g. between the frames 52 and 53 represents a readout time for the respective component, i.e. the frame 52 in this example.

For obtaining ALR data, at least two phases (or sub-frames) are used, in this embodiment.

However, if an object and/or the time-of-flight imaging system moves between two sub-frames (and if the movement speed is above a predetermined threshold), a motion blur artifact can be generated since the sub-frames are measured at different time instances.

Thereby, a computer vision (e.g. object recognition, face recognition, etc.), and the like, may be deteriorated.

Therefore, such a motion blur artifact may have to be removed.

Typically, from one sub-frame, e.g. the sub-frame 52, an MAAR signal may be obtained, as discussed above. The MAAR signal, however, contains ambient light as well as ALR, and the amount of ambient light is unknown.

Hence, the MAAR signal can be read out from one single frame (or at least one single frame), whereas, for the ALR data, at least two frames are needed.

Moreover, as it is generally known, for obtaining depth data, typically all four sub-frames (or phases) are utilized.

Thus, by reading out the sub-frames 52 to 55, a method, such as the method 1, can be carried out.

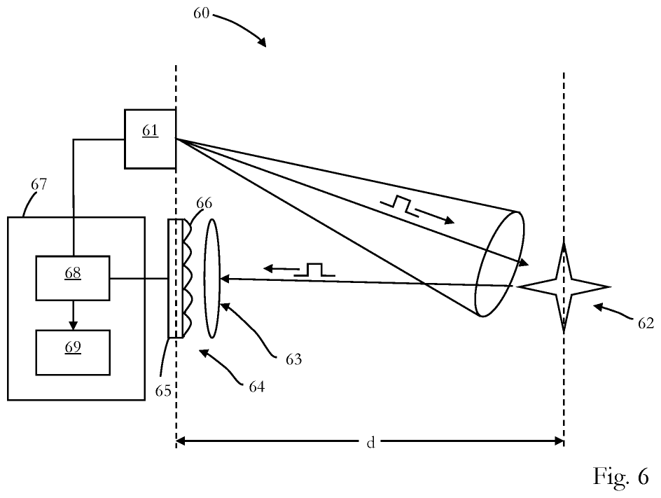

Referring to FIG. 6, there is illustrated an embodiment of a time-of-flight (To F) imaging apparatus 60, which can be used for depth sensing or providing a distance measurement, in particular for the technology as discussed herein, wherein the ToF imaging apparatus 60 is configured as an iToF camera. The ToF imaging apparatus 60 has time-of-flight object detection circuitry 67, which is configured to perform the methods as discussed herein and which forms a control of the ToF imaging apparatus 60 (and it includes, not shown, corresponding processors, memory and storage, as it is generally known to the skilled person).

The ToF imaging apparatus 60 has a modulated light source 61 and it includes light emitting elements (based on laser diodes), wherein in the present embodiment, the light emitting elements are narrow band laser elements.

The light source 61 emits light, i.e. modulated light, as discussed herein, to a scene 62 (region of interest or object), which reflects the light. The reflected light is focused by an optical stack 63 to a light detector 64.

The light detector 64 has a time-of-flight imaging portion, as discussed herein, which is implemented based on multiple CAPDs formed in an array of pixels and a micro lens array 66 which focuses the light reflected from the scene 62 to the time-of-flight imaging portion 65 (to each pixel of the image sensor 65).

The light emission time and modulation information is fed to the time-of-flight object detection circuitry or control 67 including a time-of-flight measurement unit 68, which also receives respective information from the time-of-flight imaging portion 65, when the light is detected which is reflected from the scene 62. On the basis of the modulated light received from the light source 61 and the coarse depth data and/or the precise depth data acquired in the coarse and/or precise imaging mode, the time-of-flight measurement unit 68 computes a phase shift of the received modulated light which has been emitted from the light source 61 and reflected by the scene 62 and on the basis thereon it computes a distance d (depth information) between the image sensor 65 and the scene 65.

Moreover, as discussed herein, two phases are used for obtaining reflectivity data (ALR data) and a single phase is used for obtaining MAAR data.

The depth information is fed from the time-of-flight measurement unit 68 to a 3D image reconstruction unit 69 of the time-of-flight object detection circuitry 67, which reconstructs (generates) a 3D image of the scene 62 based on the depth data, the ALR data, the MAAR data information received from the time-of-flight measurement unit 68. Moreover, object ROI detection, object detection, and object recognition, as discussed herein is performed.

It should be recognized that the embodiments describe methods with an exemplary ordering of method steps. The specific ordering of method steps is however given for illustrative purposes only and should not be construed as binding. For example, the ordering of 4 and 5 in the embodiment of FIGS. 1 and 2 may be exchanged. Other changes of the ordering of method steps may be apparent to the skilled person.

Please note that the division of the time-of-flight imaging system 40 into units 41 to 45 is only made for illustration purposes and that the present disclosure is not limited to any specific division of functions in specific units. For instance, the image sensor 42 and the time-of-flight imaging circuitry 45 could be implemented by a respective programmed image sensor, field programmable gate array (FPGA) and the like.

The methods can also be implemented as a computer program causing a computer and/or a processor, such as a CPU 45 discussed above, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A time-of-flight object detection circuitry configured to:
obtain reflectivity data being indicative of reflectivity of a scene;
determine the reflectivity of the scene;
determine a region of an object in the scene based on the determined reflectivity; and
generate time-of-flight image data based on the determined region of the object for detecting the object.

(2) The time-of-flight object detection circuitry of (1), further configured to:
adjust an exposure time based on the determined reflectivity for generating the time-of-flight image data.

(3) The time-of-flight object detection circuitry of anyone of (1) and (2), further configured to:
adjust a gain based on the determined reflectivity for generating the time-of-flight image data.

(4) The time-of-flight object detection circuitry of anyone of (1) to (3), wherein the generated time-of-flight image data includes at least one of a current image frame and at least one subsequent image frame.

(5) The time-of-flight object detection circuitry of anyone of (1) to (4), further configured to:
detect the object based on the determined reflectivity.

(6) The time-of-flight object detection circuitry of (5), further configured to:
recognize the object based on the reflectivity and based on the generated time-of-flight image data.

(7) The time-of-flight object detection circuitry of (6), wherein the recognizing is based on a predetermined object class.

(8) The time-of-flight object detection circuitry of (7), wherein the predetermined object class is defined based on a predetermined reflectivity range of the object.

(9) The time-of-flight object detection circuitry of anyone of (1) to (8), wherein the object includes a body part.

(10) The time-of-flight object detection circuitry of (9), wherein the body part includes a face.

(11) A time-of-flight object detection method comprising:
obtaining reflectivity data being indicative of reflectivity of a scene;
determining the reflectivity of the scene;
determining a region of an object in the scene based on the determined reflectivity; and
generating time-of-flight image data based on the determined region of the object for detecting the object.

(12) The time-of-flight object detection method of (11), further comprising:
adjusting an exposure time based on the determined reflectivity for generating the time-of-flight image data.

(13) The time-of-flight object detection method of anyone of (11) and (12), further comprising:
adjusting a gain based on the determined reflectivity for generating the time-of-flight image data.

(14) The time-of-flight object detection method of anyone of (11) to (13), wherein the generated time-of-flight image data includes at least one of a current image frame and at least one subsequent image frame.

(15) The time-of-flight object detection method of anyone of (11) to (14), further comprising:
detecting the object based on the determined reflectivity.

(16) The time-of-flight object detection method of (15), further comprising:
recognizing the object based on the reflectivity and based on the generated time-of-flight image data.

(17) The time-of-flight object detection method of (16), wherein the recognizing is based on a predetermined object class.

(18) The time-of-flight object detection method of (17), wherein the predetermined object class is defined based on a predetermined reflectivity range of the object.

(19) The time-of-flight object detection method of anyone of (11) to (18), wherein the object includes a body part.

(20) The time-of-flight object detection method of (19), wherein the body part includes a face.

(21) A computer program comprising program code causing a computer to perform the method according to anyone of (11) to (20), when being carried out on a computer.

(22) A non-transitory computer-readable recording medium that stores therein a computer program product, which, when executed by a processor, causes the method according to anyone of (11) to (20) to be performed.

1. A time-of-flight object detection circuitry configured to:
obtain reflectivity data being indicative of reflectivity of a scene;
determine the reflectivity of the scene;
determine a region of an object in the scene based on the determined reflectivity; and
generate time-of-flight image data based on the determined region of the object for detecting the object.

2. The time-of-flight object detection circuitry of claim 1, further configured to:
adjust an exposure time based on the determined reflectivity for generating the time-of-flight image data.

3. The time-of-flight object detection circuitry of claim 1, further configured to:
adjust a gain based on the determined reflectivity for generating the time-of-flight image data.

4. The time-of-flight object detection circuitry of claim 1, wherein the generated time-of-flight image data includes at least one of a current image frame and at least one subsequent image frame.

5. The time-of-flight object detection circuitry of claim 1, further configured to:
detect the object based on the determined reflectivity.

6. The time-of-flight object detection circuitry of claim 5, further configured to:
recognize the object based on the reflectivity and based on the generated time-of-flight image data.

7. The time-of-flight object detection circuitry of claim 6, wherein the recognizing is based on a predetermined object class.

8. The time-of-flight object detection circuitry of claim 7, wherein the predetermined object class is defined based on a predetermined reflectivity range of the object.

9. The time-of-flight object detection circuitry of claim 1, wherein the object includes a body part.

10. The time-of-flight object detection circuitry of claim 9, wherein the body part includes a face.

11. A time-of-flight object detection method comprising:
obtaining reflectivity data being indicative of reflectivity of a scene;
determining the reflectivity of the scene;
determining a region of an object in the scene based on the determined reflectivity; and
generating time-of-flight image data based on the determined region of the object for detecting the object.

12. The time-of-flight object detection method of claim 11, further comprising:
adjusting an exposure time based on the determined reflectivity for generating the time-of-flight image data.

13. The time-of-flight object detection method of claim 11, further comprising:
adjusting a gain based on the determined reflectivity for generating the time-of-flight image data.

14. The time-of-flight object detection method of claim 11, wherein the generated time-of-flight image data includes at least one of a current image frame and at least one subsequent image frame.

15. The time-of-flight object detection method of claim 11, further comprising:
detecting the object based on the determined reflectivity.

16. The time-of-flight object detection method of claim 15, further comprising:
recognizing the object based on the reflectivity and based on the generated time-of-flight image data.

17. The time-of-flight object detection method of claim 16, wherein the recognizing is based on a predetermined object class.

18. The time-of-flight object detection method of claim 17, wherein the predetermined object class is defined based on a predetermined reflectivity range of the object.

19. The time-of-flight object detection method of claim 11, wherein the object includes a body part.

20. The time-of-flight object detection method of claim 19, wherein the body part includes a face.
